(19) United States
(12) Patent Application Publication
(10) Pub. No.: US 2025/0369795 A1
(43) Pub. Date: Dec. 4, 2025

(54) EFFICIENT PROCESSING RESOURCE USAGE IN LONG RANGE, MULTI-BAND BACKSCATTERING FIBER SENSING

(71) Applicant: NEC Laboratories America, Inc., Princeton, NJ (US)

(72) Inventor: Junqiang HU, DAVIS, CA (US)

(73) Assignee: NEC Laboratories America, Inc., Princeton, NJ (US)

(21) Appl. No.: 19/218,458

(22) Filed: May 26, 2025

Related U.S. Application Data
(60) Provisional application No. 63/652,292, filed on May 28, 2024.

(51) Int. Cl. G01H 9/00; G01D 5/353

(52) U.S. Cl. CPC G01H 9/004; G01D 5/35361

(57) ABSTRACT

Disclosed are distributed fiber optic sensing (DFOS) systems and methods that more efficiently employ processing resources which in turn provide one or more of reduced chip costs, reduced processing power necessary, and more supported bands by employing more frequency bands for DFOS sensor fiber locations farther away from an interrogator, and fewer frequency bands for DFOS sensor fiber locations nearer to the interrogator such that a more balanced performance is realized for locations along the length of the DFOS sensor fiber as compared with contemporary systems and methods.

### CROSS REFERENCE TO RELATED APPLICATIONS

This application claims the benefit of U.S. Provisional Patent Application Ser. No. 63/652,292 filed May 28, 2024, the entire contents of which is incorporated by reference as if set forth at length herein.

### FIELD OF THE INVENTION

This application relates generally to distributed fiber optic sensing (DFOS) systems, methods, and structures. More particularly, it pertains to improved DFOS/Distributed Acoustic Sensing (DAS) systems and methods exhibiting more efficient use of processing resources which advantageously facilitate one or more of reduced chip cost, reduced processing power required, and implementing more bands.

### BACKGROUND OF THE INVENTION

As those skilled in the art will understand and appreciate, backscattering DFOS uses reflected light from an optical sensor fiber in which interrogation light pulses propagate. This reflected light conveys information from each location along the length of the optical sensor fiber from which it is reflected. Multi-carrier—or alternatively called multi-band—methods generate multiple frequency tones at a transmitter and decode each frequency band at the receiver. The decoded bands are then combined to reduce Rayleigh fading and increase signal-to-noise ratio (SNR) or interleaved for a higher interrogating frequency.

In practice, the performance at the location exhibiting the lowest SNR is of critical importance. Because of SNR differences exhibited at different locations along the length of the optical sensing fiber, processing multi-bands for near-end fiber is unnecessary but increases needed resources—which in turn increase both the cost and power consumption of the overall system and method employed.

### SUMMARY OF THE INVENTION

An advance in the art is made according to aspects of the present disclosure directed to DFOS systems and methods that more efficiently employ processing resources which in turn provide one or more of reduced chip costs, reduced processing power necessary, and more supported bands.

In sharp contrast to the prior art, systems and methods according to aspects of the present disclosure employ more frequency bands for DFOS sensor fiber locations farther away from an interrogator, and fewer frequency bands for DFOS sensor fiber locations nearer to the interrogator. Advantageously, and surprisingly, this inventive technique results in a more balanced performance for locations along the length of the DFOS sensor fiber as compared with contemporary systems and methods.

Additionally, the frequency bands advantageously compensate for backscatter fading, and improve the signal-to-noise ratio (SNR).

Additionally, multi-carriers are divided into several groups, with the multiple groups interleaved to increase sampling rate.

Finally, digital signal processing (DSP) operating in DFOS receiver logically divides the DFOS sensor fiber into multiple segments, such that each segment exhibits a different number of frequency bands.

### BRIEF DESCRIPTION OF THE DRAWING

FIG. 1(A) and FIG. 1(B) are schematic diagrams showing an illustrative prior art uncoded and coded DFOS systems.

FIG. 2 is a plot showing illustrative signal power along the length of a DFOS optical sensing fiber according to aspects of the present disclosure.

FIG. 3 is a schematic diagram showing illustrative DFOS interrogator according to aspects of the present disclosure.

FIG. 4 is a schematic diagram showing illustrative transmitted signal in a multi-carrier DFOS/distributed acoustic sensing (DAS) according to aspects of the present disclosure.

FIG. 5 is a schematic diagram showing illustrative optical sensing fiber segments and corresponding number of bands in use according to aspects of the present disclosure.

FIG. 6 is a schematic diagram showing illustrative combination of different code lengths and multiple bands in different segments of the optical sensing fiber according to aspects of the present disclosure.

FIG. 7 is a schematic feature diagram in hierarchical format of features and operation steps of systems and methods according to aspects of the present disclosure.

FIG. 8 is a schematic block diagram of an illustrative computer system in which aspects of the present disclosure may be executed.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

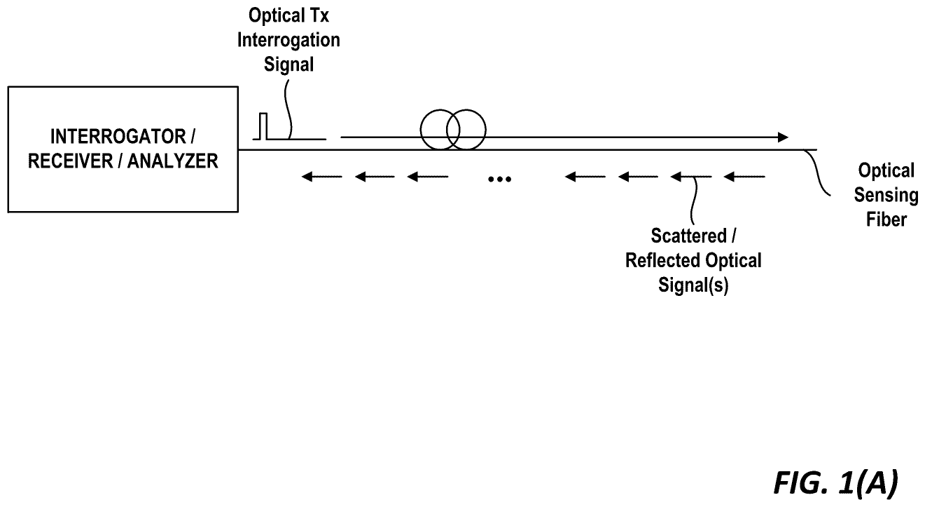

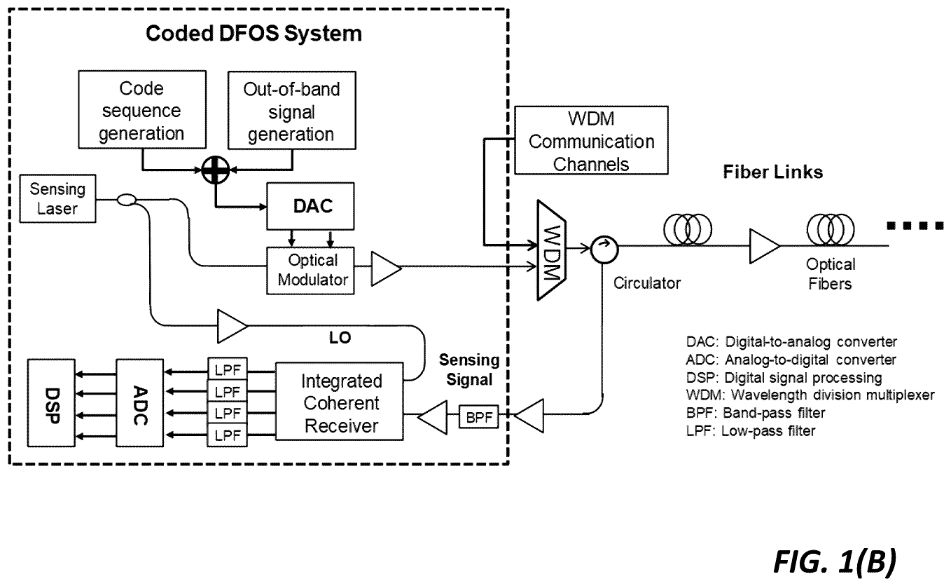

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detect/analyze reflected/backscattered and subsequently received signal(s). The signals received are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration or an indication of temperature.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows continuous monitoring over long distances, but instead of measuring temperature, it measures vibrations and sounds along the fiber.

DAS/DVS operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technologies have proven useful in a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

Distributed Fiber Optic Sensing (DFOS) technology leverages the existing fiber infrastructures as a potential sensing media, enabling a wide-range, real-time, and continuous monitoring of surrounding environment perception without the need to introduce additional sensing devices. DFOS has been successfully employed in diverse applications including road traffic monitoring, intrusion detection, earthquake detection, pipeline leakage monitoring and structure change detection.

Operational telecommunications optical fiber cable networks hold substantial potential for environmental perception and sensing applications. DFOS technology transforms existing communication cables into individual sensors distributed at every meter along the optical fiber cable, with all the measurements being synchronized. As a result, this sensing technology can be employed to detect events related to both infrastructure itself and its surrounding environments.

As previously noted, a basic principle behind the DFOS is that optical fiber cable conditions such as a change of strain or temperature on the optical fiber cable can influence the properties of the light signal traveling through an optical fiber. When pulsed light is launched into an optical fiber sensing cable, a small fraction of light is backscattered, and its properties are influenced by the fiber cable condition. The backscattered light includes three types of scattering: Raman scattering, Brillouin scattering, and Rayleigh scattering. This methodology gauges alterations in Rayleigh scattering intensity via interferometric phase beating. With coherent detection, the DFOS system retrieves comprehensive polarization and phase information from the backscattering signals, enabling impressive meter-level fiber cable sensor resolution.

As is known and noted, backscattering distributed fiber optic sensing uses the reflected light from the optical sensor fiber while the interrogation light propagates along the length of the optical sensor fiber. This reflected light conveys sensory information produced at each location along the length of the optical sensor fiber.

For a long-range application, the backscattered/reflected optical signal power drops substantially as the backscattered light travels along the length of the optical sensor fiber. For example, when a sensing distance is above 40 km in distributed acoustic sensing using Rayleigh backscattering, the power at an end of the fiber can be (2*0.2 dB/km*40 km=) 16 dB lower than at the beginning of the fiber. For 100 km case, the difference can be as high as 40 dB.

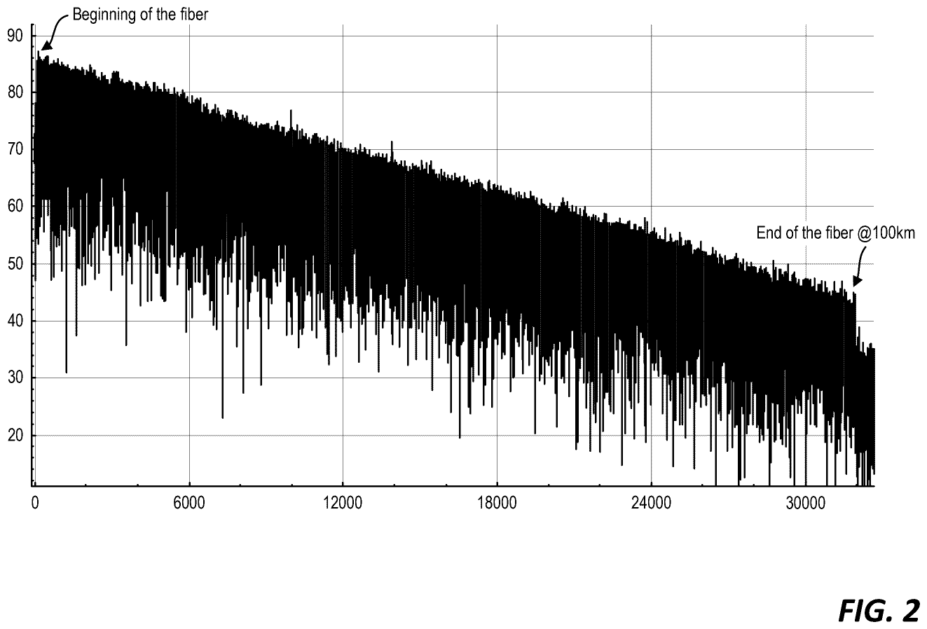

FIG. 2 is a plot showing illustrative signal power along the length of a DFOS optical sensing fiber according to aspects of the present disclosure.

As illustratively shown in this figure, the received signal power change is for locations along a 100 km fiber, where the X-axis is the locations of 3.2 m spatial resolution, and Y-axis is the relative power value in dB scale. Such power difference means significant SNR or sensitivity imbalance.

A multi-carrier (or called multi-band) DFOS method generates multiple frequency tones at a transmitter and decodes each frequency band at a receiver. The decoded band signals are then combined to reduce Rayleigh fading and increase SNR or interleaved for higher interrogating frequency. To process each band, a DFOS system usually covers the entire length of the optical fiber sensor, which needs dedicated resources for each location. Such resources include processing power and memory, wherein the memory is arguably the most critical part in firmware processing (i.e., the implementation in RTL (register-transfer level), which is typically performed by an ASIC (Application Specific Integrated Circuit), or FPGA (Field Programmable Gate Array).

In practice, however, the performance at the lowest SNR location along the length of the optical fiber sensor is the key factor to consider. Because of the SNR differences along the length of the optical fiber sensor, the processing of multi-bands for near-end locations becomes unnecessary, but increases the needed resource, which increases both the cost and the power consumption.

As we shall show and describe further, systems and methods according to aspects of the present disclosure provide efficient use of the processing resource, which in turn helps reduce one or more of chip cost, processing power required, or facilitates the implementation of more bands

As noted, the present invention considers a multi-band system in backscattering distributed fiber sensing, in particular a Rayleigh distributed acoustic sensing (DAS) system, though the method can be used in other types of systems.

The N bands are equally divided into m groups, where m is the times of interleaving. Within each group (of N/m=n bands), p bands are considered enough for Rayleigh fading compensation, and the additional (n−p=q) bands are provided for SNR improvement purpose, which increases the system sensitivity and/or the sensing reach.

The present invention logically divides the fiber into several segments, from segment 0 to q. Segment i (i=0, 1, . . . , q) combines all the (p+i) bands for each interleaving group, with the remaining (q−i) bands skipped. This means the segment more distant from the beginning of the fiber combines more bands, so that the sensitivity or SNR is relatively balanced along the fiber. Because the memory and the processing power are related to the number of bands, this method reduces the overall memory and processing power requirement or provides the potential to add more bands to the system.

The present invention may further employ using a variable code length for different segments, in combination with the number of frequency bands. As such, the near-end of the optical fiber sensor uses a shorter code and less frequency bands than the far-end of the optical fiber sensor.

The present invention processes more bands and longer code for the locations with higher loss and/or lower SNR. This includes both the processing power and the buffer. In this way the total resources required is reduced, which results in lower chip cost and lower power consumption; or with the same resource, it can use more bands, to increase the system sensitivity or reach.

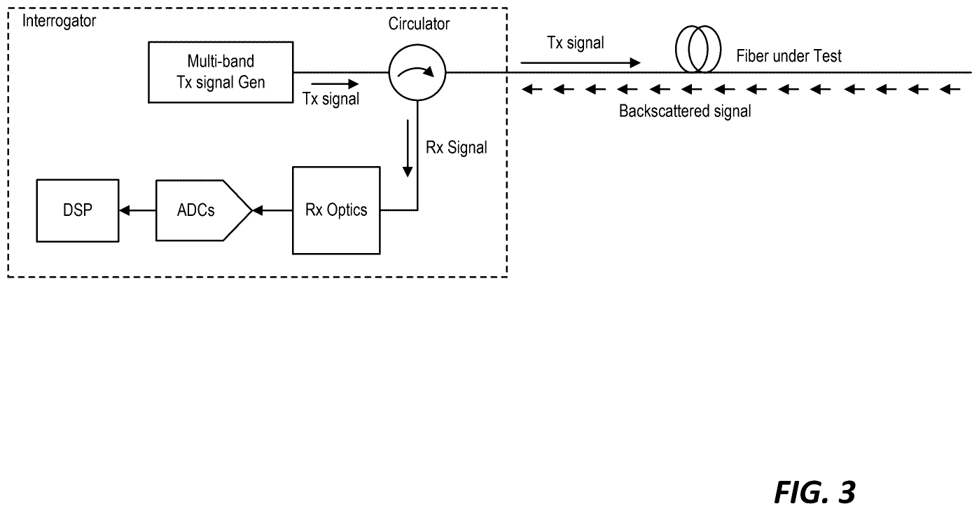

FIG. 3 is a schematic diagram showing illustrative DFOS interrogator according to aspects of the present disclosure.

With reference to that figure, shown therein is a schematic DFOS using backscattered optical signals that includes an interrogator, and the attached optical sensing fiber. The interrogator utilizes a multi-band transmission signal generator to output the optical interrogation signal with multi-frequency bands; a circulator that directs the Tx interrogation signal to the optical sensing fiber, and redirects backscattered signals to receiver (Rx) optics.

As schematically illustrated, the Rx optics convert the received optical signals into electrical signals, which are then digitized by analog-to-digital converter(s) (ADCs), the digitized signals further processed by a digital signal processor (DSP). The multi-band signal generation methods are any of a known type. Those skilled in the art will readily understand and appreciate that the received optical signals can result from Rayleigh scattering, such as those employed in distributed acoustic sensing (DAS) or distributed vibration sensing (DVS), or Raman scattering, such as those employed in distributed temperature sensing (DTS). And while the present disclosure uses DAS to show and describe our inventive methods, those skilled in the art will understand and appreciate that our inventive methods may be employed in other systems as well.

For multi-carrier DAS, the multiple frequency bands can be used for at least three purposes namely, increasing sampling rate, reducing or eliminating Rayleigh fading, and increasing signal SNR which advantageously improves the system sensitivity.

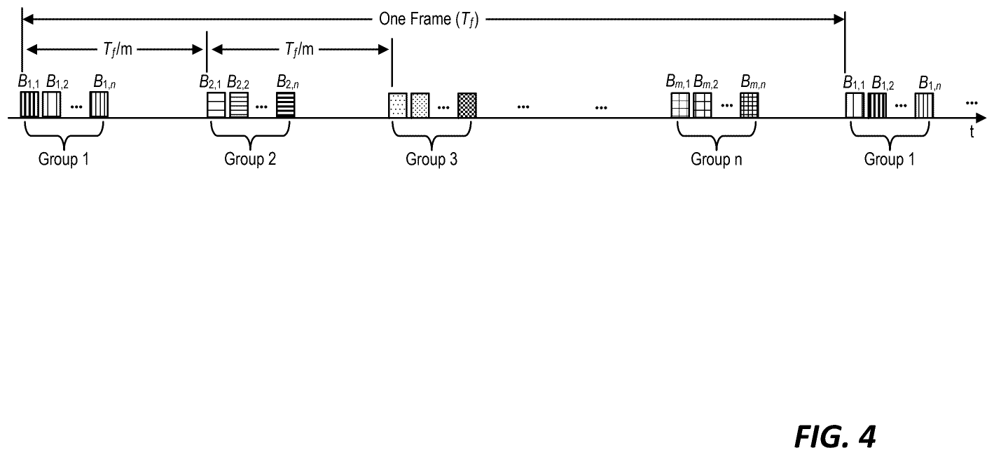

FIG. 4 is a schematic diagram showing illustrative transmitted signal in a multi-carrier DFOS/distributed acoustic sensing (DAS) according to aspects of the present disclosure.

As in the example shown in FIG. 4 illustrate, within each frame time T_{f}, there are m*n bands in total, divided into m groups, with each group containing n bands. The m groups are distributed equally in time T_{f}. For every group in one frame time, each sensing location is sampled once. If the m groups are used in interleaving mode, the sampling rate for each location becomes m/T_{f}, which means the sampling rate is m times the repetition rate. Within each group, the n bands are used to eliminate the Rayleigh fading and increase the SNR.

In practice, k (k<n, e.g., k=2 or 3) bands are sufficient to eliminate the Rayleigh fading, and the additional bands are applied to achieve a higher SNR. Consider the signal power drop as shown illustratively in FIG. 2, and the fact that near-end SNR is much higher than the far-end SNR, it is not necessary to process all the bands for all the locations. To save the processing resource, which includes the calculation/DSP resource and memory required, the invention according to aspects of the present disclosure processes only the bands needed to meet performance specifications. This means that more bands will be used for locations farther away from the interrogator, and less bands for nearer locations. This will result in a balanced performance for locations along the length of the fiber optic sensor.

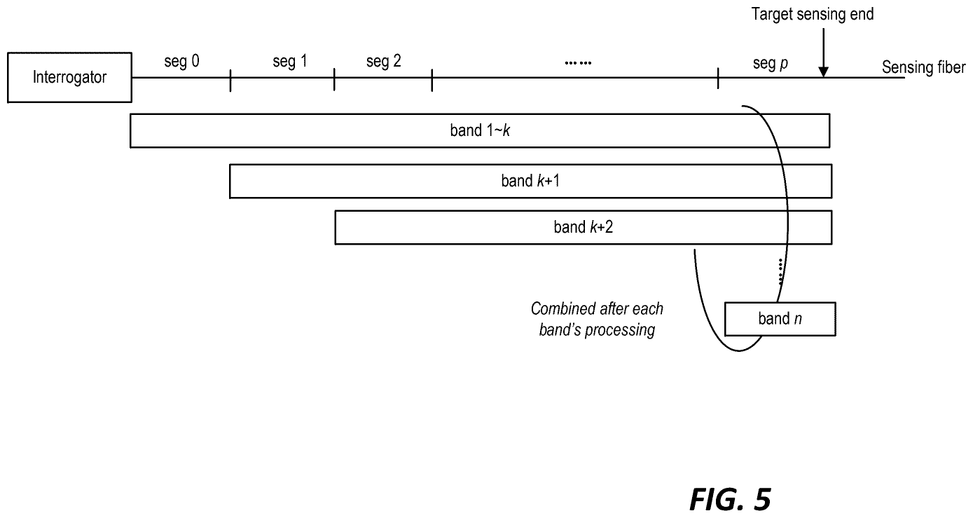

FIG. 5 is a schematic diagram showing illustrative optical sensing fiber segments and corresponding number of bands in use according to aspects of the present disclosure.

The present invention focuses on receiver side processing of the remaining (n−k=p) bands within each group. First the receiver DSP logically divides the sensing length of the fiber into (p+1) segments, numbered from 0 to p. It processes (k+s) bands for segment s (s=0, 1, . . . , p), then combines the (k+s) bands into a single output. This is shown illustratively in FIG. 5.

In DAS case, the processing of each band includes frequency shift, filtering, differential phase calculation, phase alignment, and so on, then the bands are added together. This proposed method means the farther away segment from the beginning of the fiber combines more bands, so that the sensitivity or SNR is relatively balanced along the fiber. Because the memory and the processing power are related to the number of bands and locations, this method reduces the overall memory and processing power requirement, or provides the potential to add more bands to the system

A straightforward approach involves dividing the entire sensing reach equally into (p+1) segments. However, consider the number of bands and the SNR improvement in dB scale has the relationship of 10log₁₀b+a/b, where a is the number of additional bands to b, while the power (so is the SNR) drops linearly along the fiber (also in dB scale), this is not the best approach. In practice, a system is typically configured for its specified sensing reach and/or the minimum needed SNR (SNRₘᵢₙ).

In one embodiment, the planning starts from the beginning of the fiber, using k bands, to location L₀ that reaches the SNRₘᵢₙ, then add one band; next, with the (k+1) bands, location L₁ reaches SNRₘᵢₙ, and so on. In one embodiment, the planning starts from the end of the fiber, location L_{E}, that satisfies SNRₘᵢₙ, using n bands. With n−1 bands, the location will move towards the interrogator by

$$( 10 {log}_{10} \frac{n}{n - 1} ) / {P}_{l}$$

where Pₗ is power loss in dB, per kilometer.

Repeat this calculation using

$$( 10 {log}_{10} \frac{n - i}{n - i - 1} ) / {P}_{l} ,$$

for segment i, until it reaches the first segment. For constant step size which simplifies the system configuration, each segment may use K times of bands than its previous segment. This gives the segment size of (10log₁₀K)/Pₗ. This solution applies to the case that amplifiers are deployed along the sensing fiber, which adds a roughly constant noise figure. The added bands cover this added noise figure.

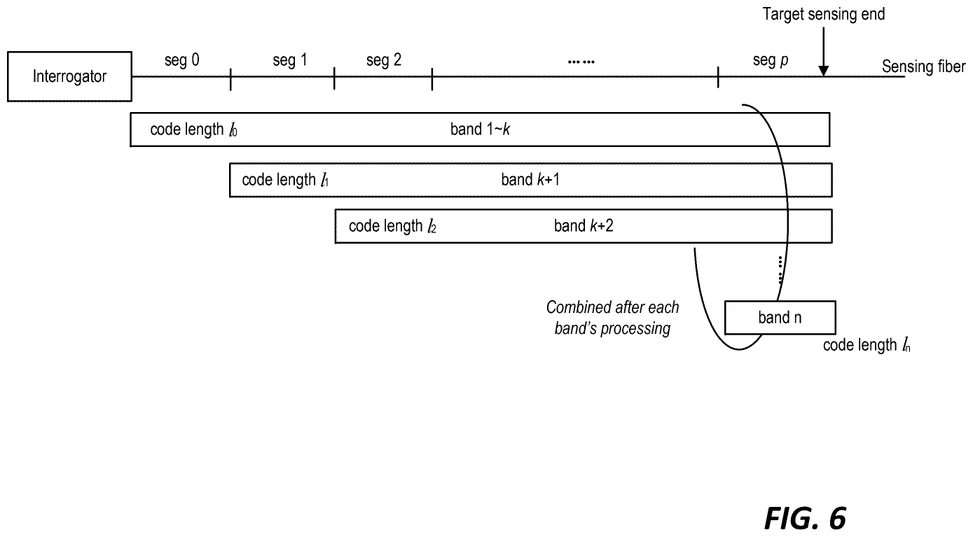

FIG. 6 is a schematic diagram showing illustrative combination of different code lengths and multiple bands in different segments of the optical sensing fiber according to aspects of the present disclosure.

For a sensing system that uses coding, the code length gives another dimension in the above arrangement. Like multi-carrier case, the code length l improves the SNR by

$$( 10 {log}_{10} \frac{{l}_{j}}{{l}_{i}} )$$

db. The code length is usually proportional to the processing complexity, so using the code length in a configurable way can have the same advantage as the number of bands. This makes it possible to consider the combination of the code length and the number of bands to maximize the benefits, as shown in FIG. 6.

Assume seg0 uses code length l₀ that meets the SNR requirement, and each step increases the code length by cₗ times and the number of bands by c_{b} times, then for each next segment, the segment size becomes

$$\frac{( 10 {log}_{10} ( {c}_{l} * {c}_{b} ) )}{{P}_{l}} .$$

Note that “band” mentioned above can be of electrical carriers, or wavelengths, or the combination of both. This proposed method can be used for either firmware (in RTL logic) implementation, or software such as CPU or GPU.

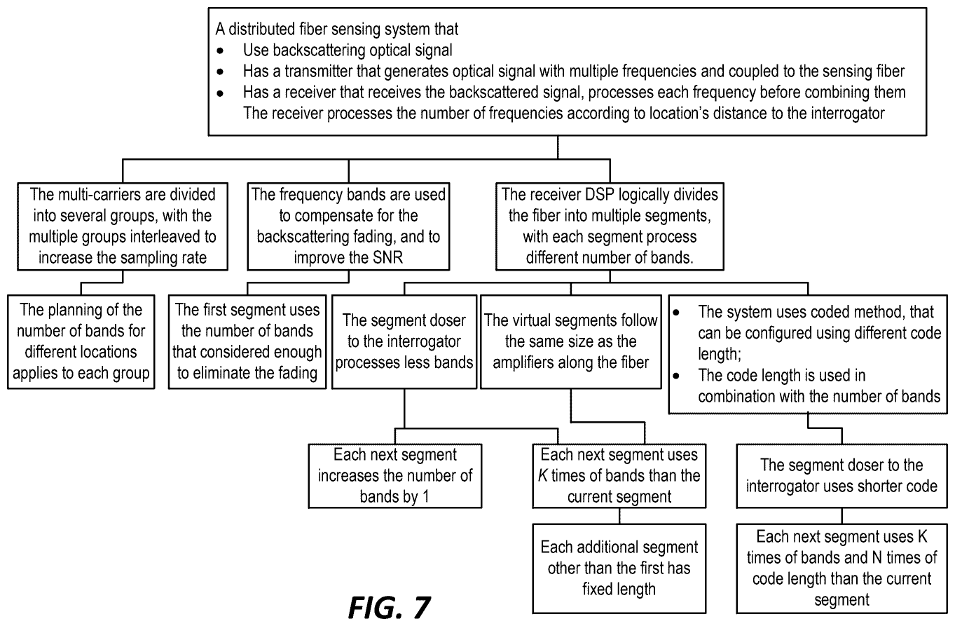

FIG. 7 is a schematic feature diagram in hierarchical format of features and operation steps of systems and methods according to aspects of the present disclosure.

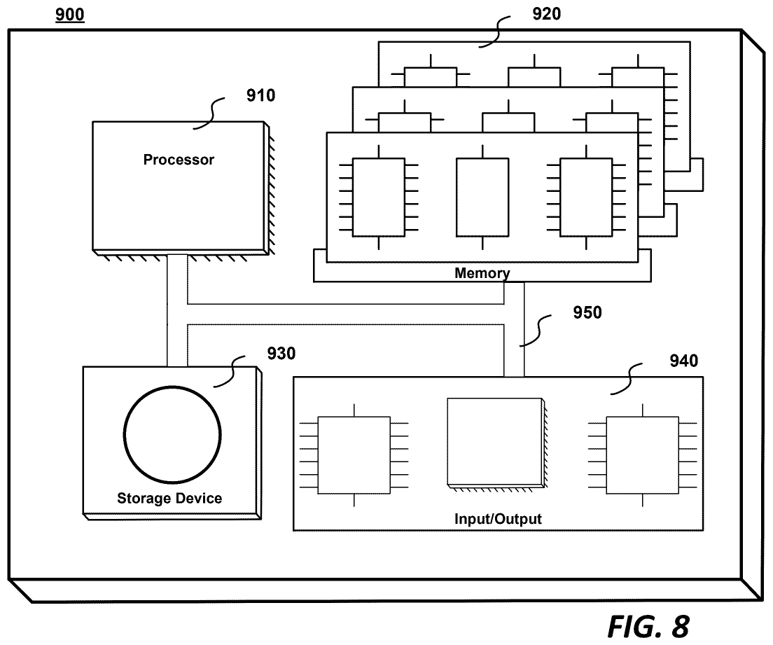

FIG. 8 is a schematic block diagram of an illustrative computer system in which aspects of the present disclosure may be executed to produce methods/algorithms according to aspects of the present disclosure.

As may be immediately appreciated, such a computer system may be integrated into another system such as a router and may be implemented via discrete elements or one or more integrated components. The computer system may comprise, for example, a computer running any of several operating systems. The above-described methods of the present disclosure may be implemented on computer system 900 as stored program control instructions.

Computer system 900 includes processor 910, memory 920, storage device 930, and input/output structure 940. One or more input/output devices may include a display. One or more busses 950 typically interconnect the components, 910, 920, 930, and 940. Processor 910 may be a single or multicore. Additionally, the system may include accelerators etc., further comprising the system on a chip.

Processor 910 executes instructions in which embodiments of the present disclosure may comprise steps described in one or more of the Drawing figures. Such instructions may be stored in memory 920 or storage device 930. Data and/or information may be received and output using one or more input/output devices.

Memory 920 may store data and may be a computer-readable medium, such as volatile or non-volatile memory. Storage device 930 may provide storage for system 900 including for example, the previously described methods. In various aspects, storage device 930 may be a flash memory device, a disk drive, an optical disk device, or a tape device employing magnetic, optical, or other recording technologies.

Input/output structures 940 may provide input/output operations for system 900.

While we have presented our inventive concepts and description using specific examples, our invention is not so limited. Accordingly, the scope of our invention should be considered in view of the following claims.

1. A method of operating a distributed fiber optic sensing system, the method comprising:
generating, by an interrogator, multi-frequency interrogation signals and introducing the generated signals into an optical sensor fiber,
receiving, backscattered optical signals from the optical sensor fiber,
processing each frequency of the received backscattered signals,
wherein the number of frequencies processed is according to a location's distance along the optical sensor fiber from the interrogator.

2. The method of claim 1 further comprising dividing the multi-frequency signals into multiple groups.

3. The method of claim 2 wherein the multiple groups are interleaved such that a sampling rate is increased.

4. The method of claim 3 further comprising logically dividing the optical sensor fiber into multiple segments.

5. The method of claim 4 wherein each one of the multiple segments exhibits a different number of frequency bands processed.

6. The method of claim 5 wherein a segment physically closer to the interrogator has fewer frequency bands processed than a segment physically further away from the interrogator.

7. The method of claim 6 wherein each segment in succession further away from the interrogator has 1 more frequency band than a preceding segment.

8. The method of claim 7 wherein each segment other than a first segment has a fixed length.

9. The method of claim 8 wherein the interrogation signals are coded and configured using different code lengths.

10. The method of claim 9 wherein the code lengths correspond to the number of bands.
